(19) United States
(12) Patent Application Publication
(10) Pub. No.: US 2011/0058359 A1
(43) Pub. Date: Mar. 10, 2011

(54) Outdoor use illumination device

(76) Inventor: Keiji Taiga, Tokyo (JP)

(21) Appl. No.: 12/585,912

(22) Filed: Sep. 29, 2009

(30) Foreign Application Priority Data
Sep. 4, 2009 (TW) 098216451

(51) Int. Cl. F21L 4/00

(52) U.S. Cl. 362/158; 362/190

(57) ABSTRACT

An outdoor use illumination device includes a frame having at least one light portion and a power unit, a control unit and a button are located in the frame, wherein a part of the button is exposed on the frame. A light unit is connected with the control unit and located corresponding to the at least one light portion. The light unit is controlled by the control unit. A casing made of waterproof material is mounted to the frame and the at least one light portion is exposed through the casing. The casing includes a flexible bridge portion on which a pressing spot is located which is located corresponding to the button. The casing includes two side portions extending from two sides thereof so as to tie the illumination device on objects.

### FIELD OF THE INVENTION

The present invention relates to an outdoor use illumination device, and more particularly, to a compact, portable and waterproof illumination device.

### BACKGROUND OF THE INVENTION

There is a need for people taking outdoor activities such as biking, climbing, diving, fishing or even emergency rescue to have a portable illumination device which has to be light, easily carry and operation and water proof.

The portable illumination devices can be used to illuminate or warn, for the purpose of illumination, the illumination device needs to be bright enough to illuminate things, and for the purpose of warning, it requires attraction to people's attention, such as the tail light of bicycles.

The portable illumination device known to everyone is flashlight which includes a tubular casing with batteries received therein and a bulb is connected to an end of the flashlight and powered by the batteries. A headlight is cooperated with a band which connects the light on a helmet so that the user's hands are free.

A bicycle head light known to applicant includes a casing, a connection member and a fixing frame, wherein the casing has a bulb located therein and two lugs extend from the casing so as to be connected to the connection member. The connection member includes an engaging portion which is connected to the fixing frame which is connected to the bicycle frame. The casing further includes batteries received therein and a terminal extends from the casing so that another power supply can also be connected to the head light device. The bicycle head light is stationary and fixed on the bicycle frame and cannot be removed from the bicycle frame.

Another illumination device includes a box having an opening, a flat battery is located at an inner bottom of the box, a circuit board with an LED bulb is located in the box, and a button is located on the box so that when the user presses the button, the LED bulb lights up. A cap is mounted to the opening where the LED bulb is located and the circuit board is connected to an extension portion of the cap. A cover made of waterproof material is mounted to the box and the cap. The illumination device is portable and can be cooperated with a band to be tied to other objects.

The bicycle head light is not waterproof and can only be used as the bicycle head light. Applicant intends to provide an improved portable illumination device.

The present invention intends to provide an outdoor use illumination device which is portable and waterproof. The illumination device is covered by a rubber made casing which includes side portions and the illumination device can be tied to an object by the two side portions.

### SUMMARY OF THE INVENTION

The present invention relates to an illumination device which comprises a frame composed of a first part and a second part, and the first part has at least one light portion. An operation device is located in the frame and includes a power unit and a control unit which is electrically connected to the power unit. A button is connected to the control unit and a part of the button is exposed on the frame. A light unit is connected with the control unit and located corresponding to the at least one light portion. The light unit is controlled by the control unit. A rubber-made casing is mounted to the frame and the at least one light portion is exposed through the casing. The casing includes a flexible bridge portion which is located corresponding to the first part and has a pressing spot protruding from the bridge portion. The pressing spot is located corresponding to the button. The illumination device is water-proof and portable can be powered by batteries such as the button-shaped batteries.

The primary object of the present invention is to provide a compact and portable illumination device which is covered by a rubber-made casing which is water proof.

Another object of the present invention is to provide a compact and portable illumination device wherein the rubber-made casing includes a flexible bridge portion and the button is located at the flexible bridge portion. The light unit is positioned by the casing.

Yet another object of the present invention is to provide a compact and portable illumination device which provides multiple light sources to provide sufficient illuminating function.

A further object of the present invention is to provide a compact and portable illumination device which can be tied to objects by its side portions.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a front perspective view to show the illumination device of the present invention;

FIG. 2 is a rear perspective view to show the illumination device of the present invention;

FIG. 3 is an exploded view to show the illumination device of the present invention;

FIG. 4 is a top cross sectional view of the illumination device of the present invention;

FIG. 5 is a side cross sectional view of the illumination device of the present invention;

FIG. 6 is another top cross sectional view to show the illumination device of the present invention;

FIG. 7 shows that the light unit is activated when the pressing spot is pressed;

FIG. 8 shows the illumination device is tied on a post, and

FIG. 9 shows a fastening member is used to connect the two side portions of the casing of the illumination device of the present invention.

### DETAILED DESCRIPTION OF THE PREFERRED EMBODIMENT

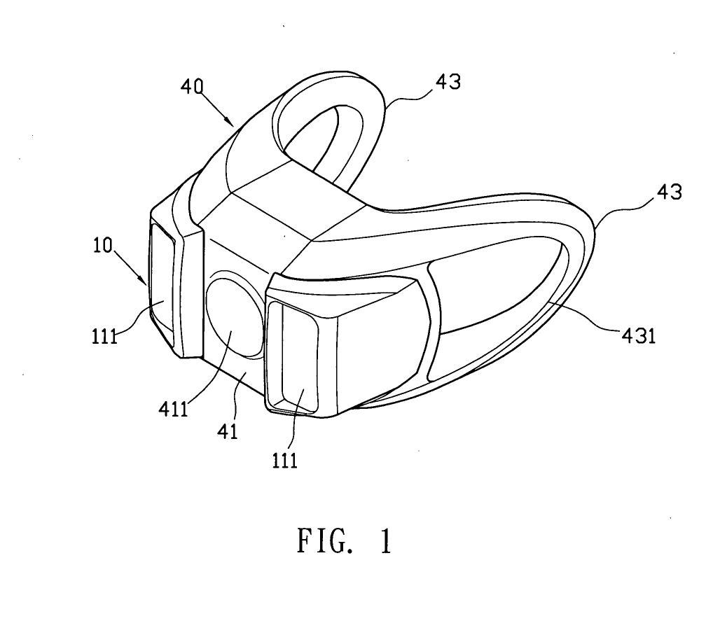

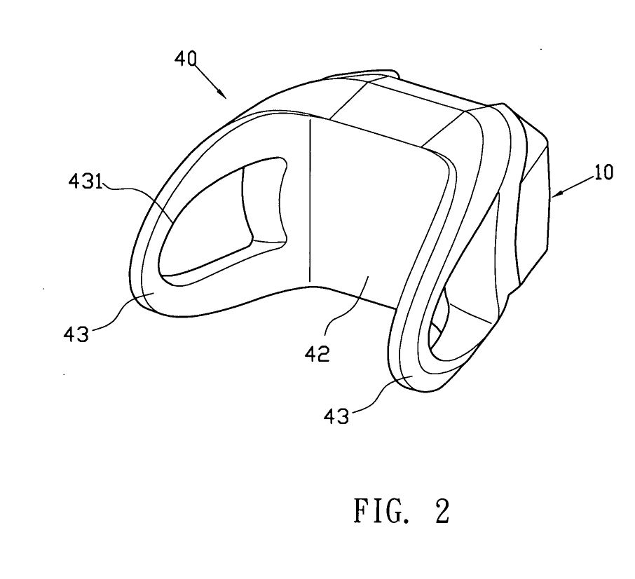

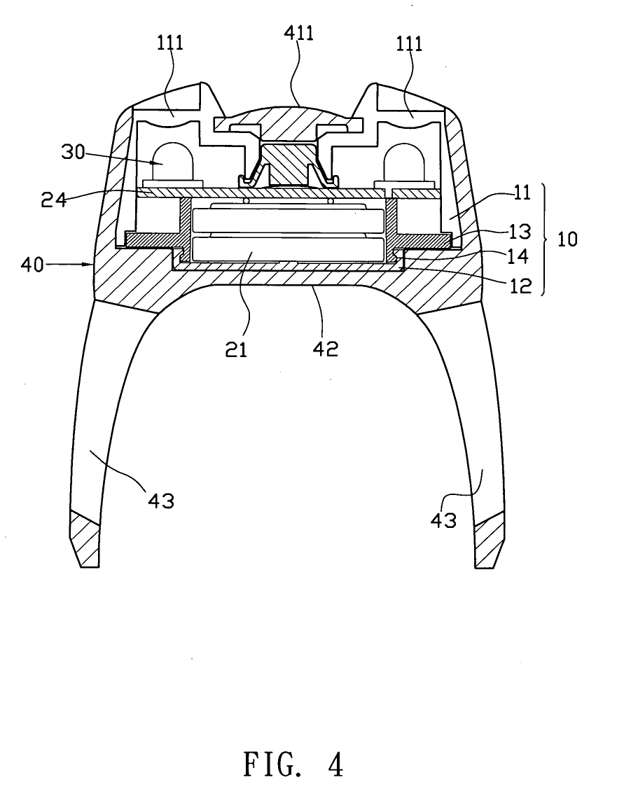

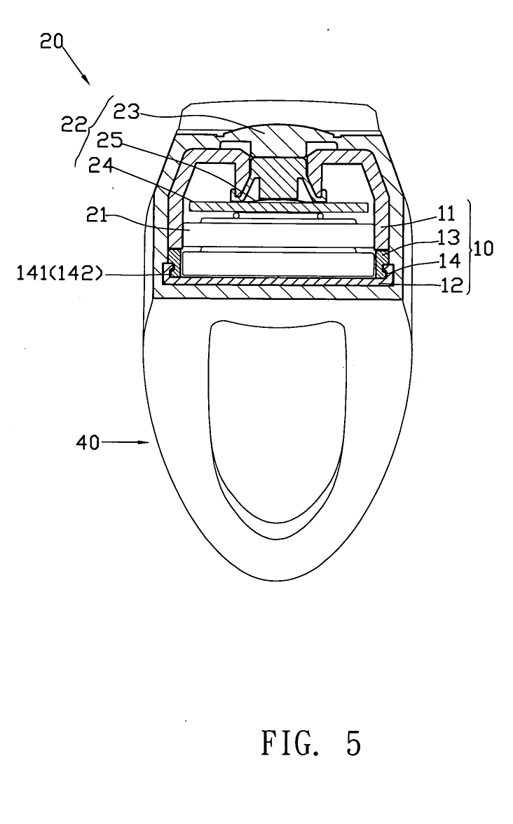

Referring to FIGS. 1 to 5, the illumination device of the present invention comprises a frame 10 having a first part 11 and a second part 12 which is connected to the first part 11 by a connection device 14 located between the first and second parts 11, 12. The connection device 14 includes first connection members 141 on the first part 11 and second connection members 142 on the second part 12, the first connection members 141 are engaged with the second connection members 142 to connect the first and second parts 11, 12. The first part 11 has two light portions 111 which are integrally formed with the first part 11 and a body 112. The two light portions 111 are made by transparent material and the body 112 can be made by non-transparent material. The two light portions 111 are parallel to each other and located at the front side of the first part 11.

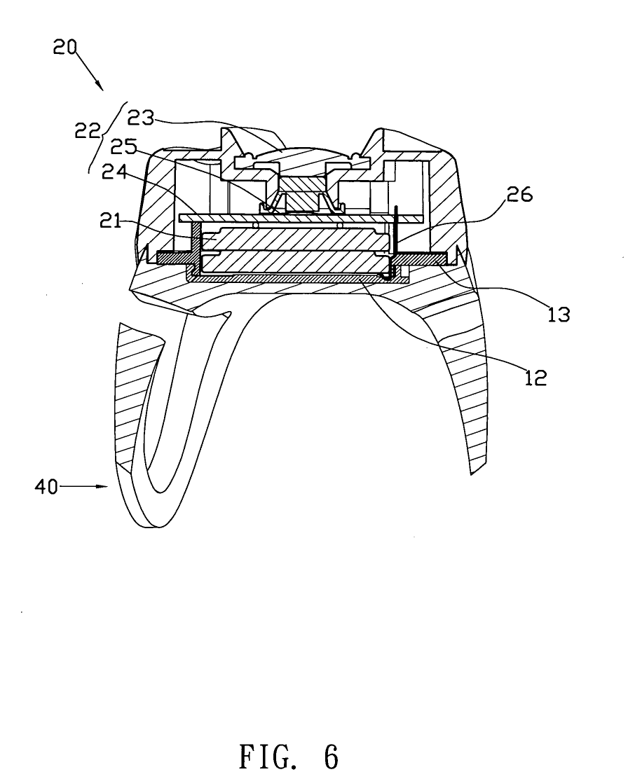

An operation device 20 is located in the frame 10 and includes a power unit 21 and a control unit 22 which is electrically connected to the power unit 21. A button 23 connected to the control unit 22 and a part of the button 23 exposed on the frame 10. The control unit 22 includes a circuit board 24 connected to the first part 11 and a spring switch 25 is connected on the circuit board 24. A conductive plate 26 is connected between the power unit 21 and the circuit board 24. The power unit 21 can be button-shaped batteries. A gasket 13 is located between the first and second parts 11, 12 so as to position the power unit 21. One end of the conductive plate 26 is connected to the gasket 13 as disclosed in FIG. 6.

A light unit 30 is connected with the control unit 22 and located corresponding to the two light portions 111. The light unit 30 is connected to the circuit board 24 and includes two LED bulbs which are controlled by the control unit 22. One LED bulb is located corresponding to each of the light portions 111 of the first part 11.

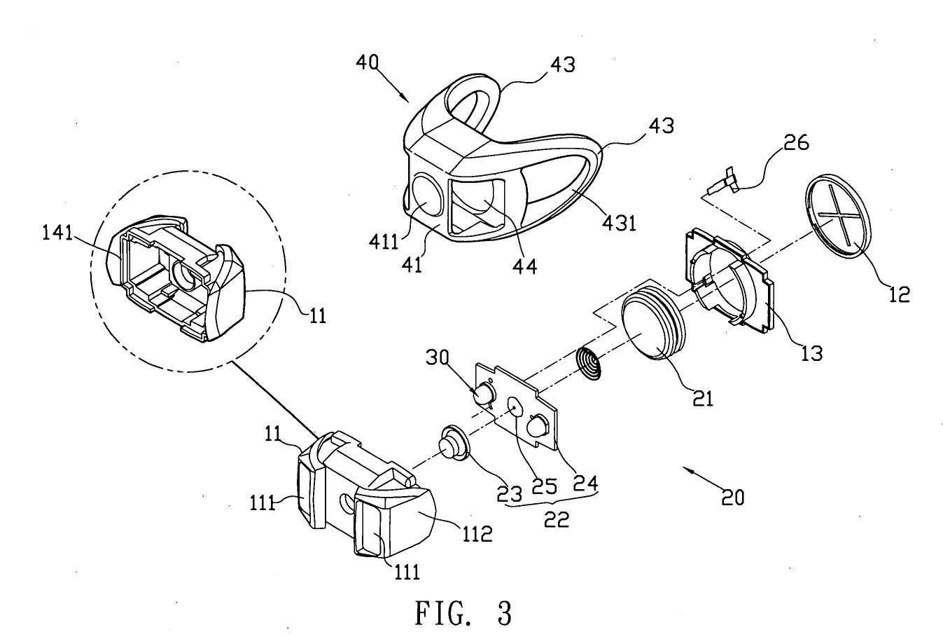

A casing 40 is mounted to the frame 10 and made by flexible and water-proof material such as rubber. The light portions 111 are exposed through the casing 40. The casing 40 includes a flexible bridge portion 41 which is located corresponding to the first part 11 and has a pressing spot 411 protruding from the bridge portion 41. The pressing spot 411 is located corresponding to the button 23. A contact surface 42 is defined on the rear end of the casing 40 and two side portions 43 integrally extend from two sides of the contact surface 42, and each side portion 43 includes a hole 431. As disclosed in FIG. 3, a positioning recess 44 is defined in the casing 40 and the second part 12 is engaged with the positioning recess 44.

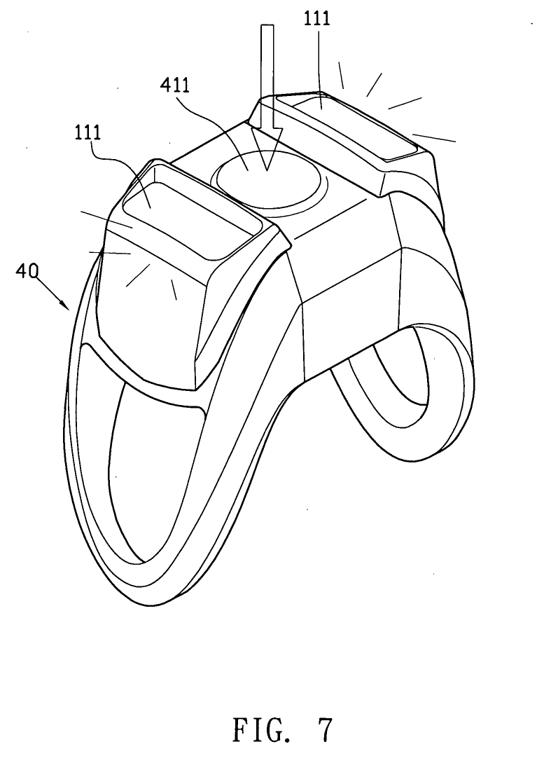

As shown in FIG. 7, when the user presses the pressing spot 411 on the casing 40, the button 23 is pressed to activate the spring switch 25 so that the LED bulbs light on. When the user presses the pressing spot 411 again, the button 23 is pressed and the spring switch 25 is pushed again and bounces back to turn the LED bulbs off.

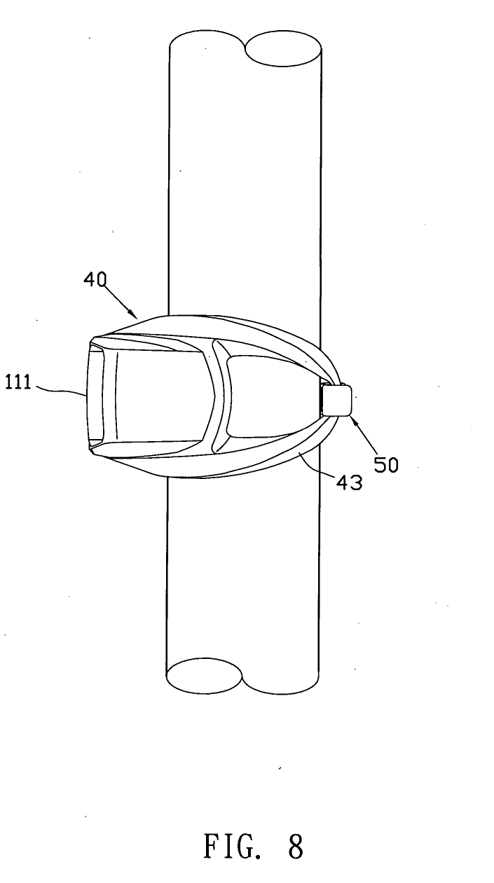

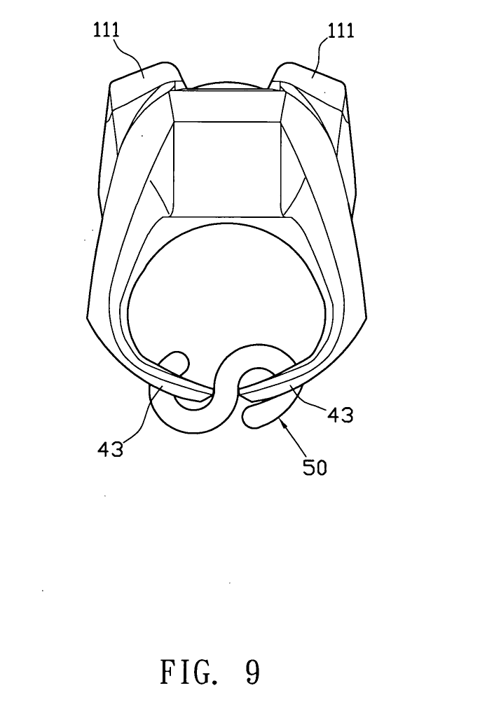

As shown in FIGS. 8 and 9, a fastening member 50 is used to connect the two side portions to tie the illumination device on a post, wherein the fastening member 50 is an S-shaped member which extends through the two holes 431 of the two side portions 43 so as to fasten the illumination device on the post. The contact surface 42 of the casing 40 contacts the post.

The casing 40 is made of waterproof material such that the illumination device can be used in wet circumstances to prevent water from entering the device to protect the control device 20 and the power unit 21. Furthermore, the rubber-made casing 40 has flexibility so that the illumination device can be easily connected to objects by the side portions 43 and the use of the fastening member 50. Therefore, the two hands of the users are not restricted to hold the illumination device. The illumination device can be held by the user or tied to a fixed object by using the fastening member 50 and the side portions 43. The range of use is wide and flexible. The operation is simple and easy, so that the illumination device is suitable for outdoor use.

While we have shown and described the embodiment in accordance with the present invention, it should be clear to those skilled in the art that further embodiments may be made without departing from the scope of the present invention.

What is claimed is:

1. An illumination device comprising:
a frame having a first part and a second part which is connected to the first part, the first part having at least one light portion;
an operation device located in the frame and including a power unit and a control unit which is electrically connected to the power unit, a button connected to the control unit and a part of the button exposed on the frame;
a light unit connected with the control unit and located corresponding to the at least one light portion, the light unit being controlled by the control unit, and
a casing mounted to the frame and the at least one light portion being exposed through the casing, the casing including a flexible bridge portion which is located corresponding to the first part and has a pressing spot protruding from the bridge portion, the pressing spot located corresponding to the button.

2. The device as claimed in claim 1, wherein the first part is integrally formed as a body with the at least one light portion.

3. The device as claimed in claim 1, wherein the first part is integrally formed as a body with the at least one light portion 111, the body is made of non-transparent material.

4. The device as claimed in claim 1, wherein the frame includes a gasket which is located between the first and second parts so as to position the power unit.

5. The device as claimed in claim 4, wherein the casing includes a positioning recess and the second part is engaged with the positioning recess.

6. The device as claimed in claim 1, wherein the control unit includes a circuit board connected to the first part and a spring switch is connected on the circuit board, the light unit is connected to the circuit board.

7. The device as claimed in claim 6, wherein the control unit includes a conductive plate which is connected between the power unit and the circuit board.

8. The device as claimed in claim 1, wherein the frame includes a gasket which is located between the first and second parts, the control unit includes a conductive plate which is connected between the power unit and the circuit board, one end of the conductive plate is fixed to the gasket.

9. The device as claimed in claim 1, wherein a connection device is located between the first and second parts which are connected to each other by the connection device.

10. The device as claimed in claim 9, wherein the connection device includes first connection members on the first part and second connection members on the second part, the first connection members are engaged with the second connection members.

11. The device as claimed in claim 1, wherein the casing includes two integral side portions.

12. The device as claimed in claim 11, wherein a contact surface is defined on the casing and the two side portions extend from two sides of the contact surface.

13. The device as claimed in claim 11 further comprising a fastening member which is an S-shaped member and the two side portions are connected to two ends of the fastening member.

14. The device as claimed in claim 1, wherein the power unit includes button-shaped batteries.

15. The device as claimed in claim 1, wherein the casing is made of waterproof material.
